(19) United States
(12) Patent Application Publication
(10) Pub. No.: US 2017/0251871 A1
(43) Pub. Date: Sep. 7, 2017

(54) APPLIANCE APPARATUS AND SYSTEM

(71) Applicant: CE Brands, LLC, Miami, FL (US)

(72) Inventor: Jorge Garcia, Rogers, AR (US)

(73) Assignee: CE Brands, LLC, Miami, FL (US)

(21) Appl. No.: 15/451,006

(22) Filed: Mar. 6, 2017

Related U.S. Application Data
(60) Provisional application No. 62/304,050, filed on Mar. 4, 2016.

(51) Int. Cl. A47J 37/06

(52) U.S. Cl. CPC A47J 37/0611

(57) ABSTRACT

The invention described discloses an appliance system that is specially configured to receive a specific food item, for example a burrito or a 12-inch pizza, cook it according to a predetermined set of temperature and time parameters, then switch to a keep warm mode to ensure that the food item does not burn if left unattended. Several key elements differentiate this appliance from other similar appliances, namely, the unit self-monitors, cooks food items and minimizes the risk of burning the user or flammable materials around the unit.

### CROSS-REFERENCE TO RELATED APPLICATIONS

This non-provisional utility patent application claims the benefit of U.S. Provisional Patent Application no. 62/304,050, filed on Mar. 4, 2016, currently pending, which is incorporated herein by reference.

### STATEMENT REGARDING FEDERALLY SPONSORED-RESEARCH OR DEVELOPMENT

None.

### FIELD OF THE INVENTION

The invention relates generally to the field of electro-mechanical apparatuses, systems and methods, and, more particularly, to a small appliance apparatus and system configured to prepare specific food items.

### BACKGROUND

For many, the prospect of having to cook and prepare their own food is a daunting proposition. For the very young, as well as for the very old, cooking can be a potentially dangerous activity. For others, such as college students, space in a dorm room or apartment may be at a premium. Safe, easy, and hassle-free cooking and heating of food is desired by many. Many attempts to solve this problem have fallen short.

There is a need in the current state of the art for a small appliance that works with specific food items. It would be desirable to have an apparatus or system that enables and empowers consumers that are not used to cooking, or have little training, to prepare their own meals. It is further desirable to have a device that will simplify the cooking experience so that either children can be empowered to cook for themselves or allow college students to cook in their rooms while studying without the concern of overcooking the food. People want to be free from having to monitor their appliances while in cooking mode. People want to be free to do other things in the kitchen or around the house without having to worry about their food burning or overcooking.

It would, therefore, be desirable to have a small appliance that works with specific food items, is optimized for particular foods, and controls cooking times and temperature. It would be further desirable to have a small appliance with cooking surface shapes that are optimized to match food shape and size. Additionally, it would be desirable to have a small appliance that, when cooking is completed, the unit will either shut off or shift into a keep warm mode.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provision; or is known to be relevant to an attempt to solve any problem with which this specification is concerned.

### SUMMARY

A preferred embodiment of the present invention is directed to a small appliance system configured to operate under specific, pre-set, cooking parameters. The small appliance system is comprised of a housing component, a one or more heating component, and a control component, where the system components are operationally communicative and configured to perform predefined method steps based upon a one or more predetermined cooking parameter.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

### BRIEF DESCRIPTION OF THE DRAWINGS

These and other features, aspects, and advantages of the present invention will become better understood with regard to the following description, appended claims, and accompanying drawings where:

FIG. 1 is a composite view of various embodiments of the present invention shown in the open and closed states

### DESCRIPTION

In the Summary above, in the Description below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or van contain not only components A, B, and C, but also one or more other components or structures.

The term “at least” followed by a number is used herein to denote the start of a range beginning with that number (which may be a range having an upper limit or no upper limit, depending on the variable being defined). For example, “at least 1” means 1 more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

Before describing in detail embodiments that are in accordance with the present invention, it should be observed that some of the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

While the specification will conclude with claims defining the features of embodiments of the invention that are regarded as novel, it is believed that the invention will be better understood from a consideration of the following description in conjunction with the figures, in which like reference numerals are carried forward.

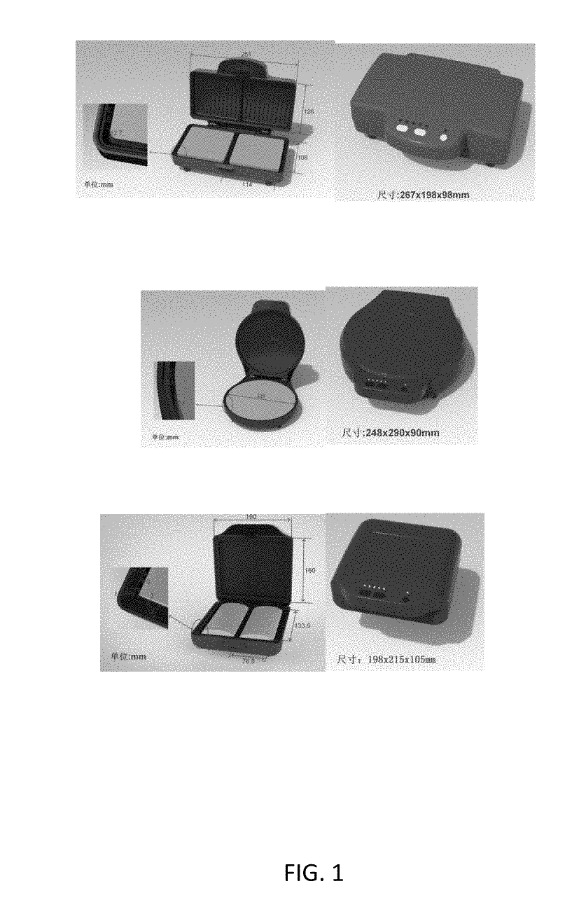

Referring to the figures in general, and to FIG. 1 in particular, we describe a preferred embodiment of the present invention that is directed to a small appliance system configured to operate under specific, pre-set, cooking parameters. The small appliance system is comprised of a housing component, a one or more heating component, and a control component, where the system components are operationally communicative and configured to perform predefined method steps based upon a one or more predetermined cooking parameter.

The housing component is configured to mechanically and electrically maintain all of the system components and sub components in operational communication. In certain embodiments, the housing component may comprise a base housing and a lid housing. The housing component may further comprise such mechanical and electrical features as may be required to accommodate hinges, latches, handles, buttons, switches, displays, electronics, and other system components present in order to carry out the pre-set cooking parameters.

The one or more heating component is configured to convert electrical power into heat that is transferred to the food to be cooked. Embodiments of the heating component comprise a one or more heating element, a one or more, temperature sensor, and a one or more cooking plate. The one or more heating component is mechanically constrained within the housing component and electrically connected to the control component.

The control component is configured to execute the one or more predetermined method steps by monitoring the one or more temperature sensor and regulating power to the one or more heating element based upon the parameters set in the cooking profile for the particular food type selected. Embodiments of the control component may comprise a special purpose microcontroller that is adapted to receive inputs from the user and from the temperature sensor, perform a series of predetermined instructions, and output instructions to regulate power to the heating element. Embodiments of the control component may be realized as discrete electrical and mechanical components, or as integrated circuits, or as a combination thereof.

By way of example and not limitation, an embodiment of the invention may be realized as a system comprised of a lower heating component, an upper heating component, a housing component, and a control component where the system is configured to accept a twelve inch frozen pizza, cook it based on a set of predetermined parameters and method steps, then shift to a standby mode.

A method related to this system embodiment comprises the following method steps:

Providing a small appliance system comprised of a lower heating component, an upper heating component, a housing component, and a control component where the system is configured to accept a twelve inch frozen pizza;

Receiving by the control component a signal to turn on;

Accessing into memory by the microcontroller of the predetermined cooking parameters;

Sensing by the temperature sensors the temperature of the upper heating component and the lower heating component;

Receiving of the temperatures sensed by the temperature sensors by the control component;

Comparing by the control component of the sensed temperature compared with the desired temperature in the predetermined cooking parameters;

Heating of the heating elements by the control component by closing a control circuit and regulating the temperature to the heating elements;

Monitoring of the temperature of the heating components;

Maintaining the heating components at the predetermined temperature for the prescribed time interval by the control component;

Lowering the temperature of the heating components at the end of the prescribed time period by the control unit;

Maintaining the heating components at a keep warm temperature for a prescribed interval of time; and

Turning off the system after a prescribed interval of time or after a predetermined temperature has been reached,

Whereby the system has cooked the specific food, in a safe manner, based upon the predetermined set of instructions and cooking parameters.

It is understood that the variations and options disclosed above with respect to the components of the apparatus embodiments, are also applicable as variations and options with respect to the components for the system embodiments.

Additional embodiments of the invention include:

systems that are pre-programmed for more than one food type;

systems that additionally include visual or audible feedback components;

systems that are configured to accept new program instructions in order to be updated to cook new food types; and

systems that are configured with concealed heating elements or heating plates that are not exposed.

Other exemplars include small appliance systems as disclosed herein that are adapted to receive a burrito, a quesadilla, a wrap, a sandwich, or other food preparation. Units can be configured to accepts specific food items such as Grilled Cheese Sandwiches, Pizza's, Hot Pockets, Pizza Rolls, Campbell's Soups, Chef Boyardee, and oatmeal.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

1. A small appliance system, the system comprising:
a housing component;
a one or more heating component integral to the housing component; and
a control component integral to the housing component and operatively connected to the one or more heating component,
whereby, the system is configured to perform a one or more predefined method steps based upon a one or more predetermined cooking parameter.
